(19) United States
(12) Patent Application Publication
(10) Pub. No.: US 2006/0219640 A1
(43) Pub. Date: Oct. 5, 2006

(54) Method for handling waste material generated in a metallurgical process

(76) Inventors: Leena Lehtinen, Pori (FI); Aimo Jarvinen, Kokkola (FI)

Correspondence Address: MORGAN & FINNEGAN, L.L.P., 3 WORLD FINANCIAL CENTER, NEW YORK, NY, 10281-2101, US

(21) Appl. No.: 10/553,855

(22) PCT Filed: Apr. 21, 2004
(86) PCT No.: PCT/FI04/00242

§ 371 Date: Oct. 19, 2005

(30) Foreign Application Priority Data
Apr. 23, 2003 (FI) 20030612

(51) Int. Cl. C02F 1/52

(52) U.S. Cl. 210/722

(57) ABSTRACT

The invention relates to a method for improving the filterability and washing result of fine-grained waste material generated in the metallurgical industry. According to the method some of other fine-grained solid is added to the first waste precipitate before filtration, which is also removed from the process, and which remains stable in the same conditions as the first waste precipitate.

The invention relates to a method for improving the filterability and washing result of fine-grained waste material generated in the metallurgical industry. According to the method some other fine-grained solid is added to the first waste precipitate before filtration, which is also removed from the process, and which remains stable in the same conditions as the first waste precipitate.

The liquid should be removed as well as possible from a poorly soluble precipitate to be-disposed of as waste, first of all in order to keep the amount of waste small. The liquid present in the solid may contain valuable substances, the recovery of which is justified economically. In addition, it is especially important that the content and quantities of substances remaining in the liquid (i.e. the moisture left in the precipitate) that are harmful to the environment are as small as possible. These harmful substances are either transported to the waste area or in most cases they have to be made insoluble often separately, with an expensive treatment stage. In particular, when fine-grained slurry is concerned, the filterability of the slurry is often weak. Filterability is usually improved using flocculants for example, which are generally organic compounds. One way to improve the filtration of a fine-grained material is to precipitate first for instance a layer of diatomaceous earth or some compound of it on the surface of the precipitation drum or belt. Such a method is described for instance in U.S. Pat. No. 5,223,153, where iron hydroxides are removed from water by means of a calcium silicate additive. The calcium silicate is at least partially recovered after filtration.

When waste material generated in the metallurgical industry is concerned, it is not worth using filtration additives that must be recovered after filtration.

According to the present invention it has now been found that the filterability of a first fine-grained waste material generated in the metallurgical industry can be improved by mixing into it at least one other fine-grained waste material that remains stable in the same kind of conditions as the first waste material, before the filtration stage. It is preferable that the particle size of the second waste material is larger than the particle size of the first waste material, and/or that the particle shapes of the waste materials differ clearly from each other and/or the materials have a surface charge of opposite signs.

It is advantageous for the method if the amount of waste material with the larger particle size is 5-50% of the amount of the material with the smaller particle size.

The essential features of the invention will be made apparent in the attached claims.

The solution according to the present invention can be applied for example in the treatment of precipitates that are generated during the hydrometallurgical fabrication of zinc for example, and that have to be removed from the process. In this connection the first waste material refers to iron precipitate and the second to gypsum precipitate. The invention is not however restricted to the fabrication of zinc, but the method can also be used when combining other waste materials to improve their filterability and washing result, provided they are stable in the same conditions. Thus the method can be used in the filtering of for instance metal hydroxide precipitates and gypsum precipitate, but also of other precipitates generated in the metallurgical industry differing in particle size and shape and/or containing polar groups.

Sulphidic zinc concentrate contains a considerable amount of iron, and this is removed from the process either as goethite, jarosite or hematite. The process stages include the leaching of zinc from the concentrate or calcine, and the precipitation of iron in the desired form. The zinc sulphate solution is routed via solution purification to the electrolytic recovery of zinc. Regarding the movement of solids, the final stage of the process is iron precipitation, when a slurry containing iron in the solids and a solution containing zinc sulphate, is conveyed to filtration.

In particular jarosite precipitate is very fine-grained, with a particle size varying between 5-25 μm depending on the jarosite grade, and its filterability and especially the washing result is poor. Jarosite precipitate consists of spherical crystals. When the precipitate remains moist, it means that water-soluble metals such as zinc, cadmium and iron as well as sulphuric acid remain in the moisture in the precipitate. It is desirable to reduce the amount of zinc as much as possible for reasons of process productivity and cadmium is a harmful substance in the waste, but iron also has to be precipitated and the acid neutralized before the waste can be deposited in the waste area. The precipitate is washed with water during filtration but despite this, a small amount of metals generally remains in the precipitate. However it is clear that the metal residues left in the precipitate are treated to become insoluble before the precipitate is routed to the storage area. Additives e.g. hydroxides, such as sodium hydroxide, are used in the neutralization of water-soluble metals, and after this the metals are precipitated with sulphide compounds into insoluble sulphide compounds. The price of the neutralization additive forms a considerable part of the treatment costs of iron precipitate waste material so that the costs of soluble metal neutralization and sulphidation are lowered significantly when the filterability and washing result of the iron precipitate are improved.

The filterability of iron precipitate, in particular jarosite precipitate, increases somewhat when flotation is performed upon it to separate sulphur concentrate from the precipitate. Sulphur concentrate separation from an iron precipitate ensures that no unwanted changes occur in the iron precipitate during storage as a result of possible reactions between the sulphur and the iron. Sulphur concentrate therefore does not necessarily remain stable in the same conditions as iron precipitate.

There is usually also some magnesium in the zinc sulphate solution that goes to electrolysis. Magnesium does not cause problems in the leaching of zinc-containing raw materials nor in solution purification. In electrolysis, however, magnesium greatly increases energy consumption and lowers the zinc content of the solution, which increases solution circulations and increases steam consumption in solution purification. In order to reach the optimal Mg level, the Mg level is adjusted by running some of the filtrate from the iron precipitate filters to magnesium removal.

Mg removal is based on the precipitation of metal hydroxides, when calcium hydroxide for example is used as a neutralizing agent. The principle is to take part of the iron precipitate filtrate into a side-stream, neutralize the free sulphuric acid contained in this solution and precipitate the majority of the metals in the solution with the exception of magnesium as a gypsum-hydroxide precipitate. The magnesium removal from circulation occurs by directing the Mg-containing solution first to water treatment and by then removing the solution from the zinc process. The metal hydroxides of the gypsum-hydroxide precipitate are leached into return acid, which is routed to zinc raw material leaching, and the gypsum precipitate generated as leaching residue is a waste precipitate. The average particle size of gypsum precipitate is at least twice that of the iron precipitate and the generated crystals are needle-shaped. Gypsum precipitate remains stable in the same conditions as the iron precipitate generated in the production of zinc, whether goethite, jarosite or hematite.

Now it has been found that combining a gypsum-containing waste material of coarser particle size with an iron-containing waste material before filtration, the filterability of the combined precipitate improves significantly in comparison with the earlier filterability of the iron precipitate. It seems to be that the needle-shaped crystals of the gypsum precipitate make the iron precipitate more porous, whereby filterability is improved. When filterability is improved, it also means that the metal-containing solution in the iron precipitate is washed out better than before in the washing that occurs in connection with filtering, and the moisture remaining in the precipitate is mainly water. This may be possible to achieve also by means of additives, but in any case the latter raise the overall costs of the process. It has been shown that the preferred quantity of gypsum precipitate is 10-30% of the quantity of iron precipitate.

The invention is described further by means of the following example.

### EXAMPLE

A study was carried out into how the filterability of jarosite precipitate from a commercial-scale zinc production plant changed, when the method was adopted according to the present invention of mixing together two precipitates of different particle size. Half a year was chosen as the length of the study period, in order to minimize the significance of chance variations.

During the first three months the filtration of jarosite precipitate took place in the conventional fashion using several belt filters. The particle size of the jarosite precipitate was around 3 μm. Gypsum precipitate was filtered either separately, or if there was only a small amount, precipitate was added randomly to the feed tank of one filter or directly onto one belt filter.

During the next three-month period, gypsum precipitate was added to the jarosite precipitate so that the precipitates could be mixed together before being fed to the belt filters. Thus each filter also received gypsum precipitate evenly. The number of filters remained the same as in the first stage. The amount of added gypsum precipitate was about 10-25% the quantity of jarosite precipitate. The particle size of the gypsum precipitate was around 15 μm. After filtration, the water-soluble metal precipitates were neutralized using sodium hydroxide and were turned into insoluble compounds by sulphidation. It was found that in the final three-month period NaOH consumption had fallen to less than half the earlier amount. No other major changes in the quantities of precipitate for filtering or in process conditions occurred during the time of the study.

1. A method to improve the filterability of the first fine-grained waste material generated in a metallurgical industry, characterized in that before filtration at least one other fine-grained waste material is added to the first waste material, which has a particle size that is either larger than the particle size of the first waste material, and/or that the particle shape clearly differs from that of the first waste material, and/or that its surface charge is of the opposite sign to the first waste material, and that the materials remain stable in the same kind of conditions.

2. A method according to claim 1, characterized in that the first waste material is an iron precipitate generated during the fabrication of zinc.

3. A method according to claim 1 or 2, characterized in that the first waste material is jarosite precipitate.

4. A method according to claim 1 or 2, characterized in that the first waste material is goethite precipitate.

5. A method according to claim 1 or 2, characterized in that the first waste material is hematite precipitate.

6. A method according to one of the above claims 1-5, characterized in that the second waste material is gypsum precipitate.

7. A method according to one of the above claims 1-6, characterized in that the amount of the second waste material to be added is 5-50% of the amount of the first.

8. A method according to one of the above claims 2-6, characterized in that the amount of second waste material to be added is 10-30% of the amount of the first.

9. A method according to one of the above claims 1-5, characterized in that the particle size of the first waste material is in the region of less than 30 μm.

10. A method according to one of the above claims 1 or 6-9, characterized in that the particle size of the second waste material to be added is at least twice as large as the particle size of the first waste material.

11. A method according to claim 1, characterized in that the first waste material is hydroxide precipitate.

12. A method according to claim 1 and 11, characterized in that the second waste material is gypsum precipitate.

13. A method according to claim 1, characterized in that the particle shape of one waste material is spherical and the other needle-shaped.
